(19) United States
(12) Patent Application Publication
(10) Pub. No.: US 2025/0154892 A1
(43) Pub. Date: May 15, 2025

(54) THERMOSTATIC VALVE

(71) Applicant: VERNET, Ollainnille (FR)

(72) Inventor: Thierry Hautcoeur, Saint Loup des Vignes (FR)

(21) Appl. No.: 18/833,365

(22) PCT Filed: Jan. 25, 2023
(86) PCT No.: PCT/EP2023/051746

§ 371 Date: Jul. 25, 2024

(30) Foreign Application Priority Data
Jan. 26, 2022 (FR) FR2200665

(51) Int. Cl. F01P 7/16; G05D 23/02

(52) U.S. Cl. CPC F01P 7/16; G05D 23/022

(57) ABSTRACT

The invention relates to valves including housing and a thermostatic element, including a fixed portion and a mobile portion. A first plug is axially movable relative to a first seat in order to control the flow of fluid between first and second paths and is carried by the mobile portion in such a way that it moves the first plug by causing it to remain in the closed configuration when deployed below a predetermined stroke and to move to an open configuration when deployed beyond that stroke. A second plug is axially movable relative to a second seat in order to control the flow of fluid between the first and a third path and is carried by the mobile portion in such a way that it moves the second plug from the closed configuration to the open configuration when deployed below the predetermined stroke.

### FIELD

The present invention relates to a thermostatic valve.

### BACKGROUND

In many applications in the fluidic field, in particular for the cooling of internal combustion engines, thermostatic valves are used to regulate the flow of a fluid through the valve, i.e. to distribute the fluid between different flow paths via the valve, in particular according to the temperature of this fluid. Such valves are called thermostatic valves in the sense that the displacement of the internal plug(s) thereof relative to the fixed seat(s) of the valve is controlled by a thermostatic element, i.e. an element which comprises a body, containing a thermally expandable material, and a piston, immersed in the thermally expandable material, the body and the piston being movable relative to each other in translation along the longitudinal axis of the piston.

EP 2 104 015 A1 discloses an example of such a valve, wherein the same thermostatic element actuates the two plugs in reverse. Another example of such a valve is provided by DE 20 2010 017 643 U1 which discloses a valve including two plugs, namely a main disk and a bypass disk: the main disk is supported by the movable part of a thermostatic element so as to be driven to open/close with respect to a seat integrated into a housing of the valve, the seat being formed by a main body of the housing; the bypass disk also being supported by the movable part of the thermostatic element, in such a way as to be driven to open/close with respect to a seat integrated into the valve housing, the seat being formed by a dedicated ring which is directly mounted in a sealed manner inside the main body of the housing; the two disks opening simultaneously and also closing simultaneously.

The design of such a thermostatic valve is of variable complexity depending, among other things, on the number of plugs, the constraints of implantation of the valve, and the specificities of the flow regulation through the valve. A common approach in the field is that the valve housing, to which a fixed part of the thermostatic element is fixedly connected and which incorporates the attached seat(s) the plug(s) of which are controlled to move, respectively, to regulate the flow of fluid through the valve, is made in a plurality of distinct parts, which are fixedly assembled to each other during the assembling of the valve. DE 10 2009 050 550 discloses an example of such approach. In practice, however, the use of a plurality of parts to form the valve housing can complicate the assembly of the valve, increasing the number of assembly operations required. The overall cost of the valve may be thereby affected.

### SUMMARY

The invention is particularly concerned with thermostatic valves used in the cooling circuits of internal combustion engines, particularly same of motor vehicles, of heavy goods vehicles, of two-wheel vehicles and of stationary engines. Nonetheless, the invention is not limited to such field of application, in the sense that the valve according to the invention can be used in various other fluid circuits, e.g. gearbox cooling circuits, oil circuits, etc.

The invention is more specifically concerned with valves with at least three paths, in particular which distribute at least one fluid inlet between at least two fluid outlets or which feed at least one fluid outlet via at least two fluid inlets. Such valves with at least three paths are typically used to regulate the circulation of a cooling fluid with respect to both an engine to be cooled by the fluid and a heat exchanger, more particularly a radiator, cooling the fluid: when the fluid has too high a temperature at the valve, the latter sends the fluid to the heat exchanger via a dedicated path to be cooled before being sent to the engine to be cooled and then returned to the valve, whereas, when the temperature of the fluid is sufficiently low at the valve, the latter sends the fluid directly to the engine from where the fluid is returned to the valve, via a bypass path that does not pass through the heat exchanger, commonly known as a bypass path. To this end, the valve includes a plug, which controls the circulation of the fluid in the main path, and another plug, which controls the circulation of the fluid in the bypass path.

The goal of the present invention is to propose a novel thermostatic valve which, while ensuring specific flow regulation, is economical, reliable and easy to assemble.

To this end, the subject matter of the invention is a thermostatic, as defined in claim 1.

By means of the invention, one and the same part forming the housing of the thermostatic valve incorporates the two seats with respect to which the two plugs are movable. The two plugs are moved by the movable part of the thermostatic element so that, when the thermostatic element expands, both open but one after the other, i.e. for respective deployments of the movable part relative to the fixed part of the thermostatic element, which are different from each other. Such regulation of the flow of fluid through the valve according to the invention thereby makes it possible that (i) when the thermally expandable material is not or is insufficiently expanded, both plugs are closed, which cuts off the flow of fluid through the valve housing, (ii) when the thermostatic material is expanded and entails a deployment of the movable part relative to the fixed part that remains within a predetermined non-zero stroke, one of the two plugs remaining closed while the second plug opens, which allows fluid to flow between two of the three paths of the valve housing, and (iii) when the thermally expandable material is so expanded that same entails a deployment of the movable part beyond the aforementioned predetermined stroke, both plugs are open, which allows fluid to flow through the valve between the three paths of the housing. The specificities of such regulation are all implemented by resorting, for the housing, to a single-piece structure, e.g. made of metal, typically aluminum, or plastic: the number of parts of the valve according to the invention is thereby limited. Moreover, by providing that, in orthogonal projection on a geometric plane perpendicular to the axis of the thermostatic element, the first plug is inscribed inside the seat associated with the second plug, the assembly of the valve according to the invention is also thereby simplified, by allowing the first plug to be inserted inside the housing via the inside of the seat associated with the second plug. Such assembly can be further simplified by advantageous arrangements which will be discussed in detail thereafter. In all cases, the valve according to the invention is thereby practical and economical.

Advantageous additional features of the thermostatic valve according to the invention are specified in claims 2 to 9.

### BRIEF DESCRIPTION OF THE DRAWINGS

The invention will be better understood upon reading the following description, given only as an example and making reference to the drawings, wherein:

FIG. 1 is a perspective view of a valve according to the invention;

FIG. 2 is a partial section in plane II of FIG. 1, illustrating the valve in an operating configuration; and

FIGS. 3, 4 and 5 are views similar to FIG. 2, illustrating the valve in respective operating configurations, which are both different from each other and different from the operating configuration illustrated in FIG. 2.

### DETAILED DESCRIPTION

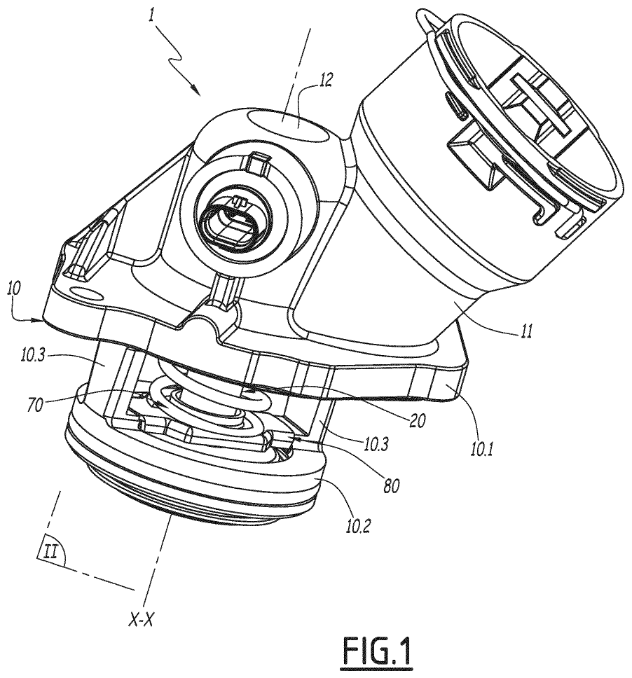

FIGS. 1 to 5 show a thermostatic valve 1 for regulating the circulation of a fluid between at least three paths connected to a circuit to which the valve 1 belongs. The fluid is e.g. a cooling fluid, the valve 1 then belonging e.g. to a cooling circuit of an internal combustion engine, in particular a motor vehicle engine.

In the embodiment considered in the Figures, the aforementioned paths are three and are referenced by 1A, 1B and 1C, respectively. As explained in detail thereafter, the valve 1 serves to control the flow of the fluid therethrough, from at least one of the paths 1A, 1B and 1C to at least one other of said paths. The paths 1A, 1B and 1C form either a fluid inlet and two fluid outlets, or two fluid inlets and one fluid outlet with respect to the valve 1.

As an application example, but not limited to, which will be mentioned again thereafter, when the valve 1 belongs to a cooling circuit of an engine, the path 1A forms an inlet for fluid coming from the engine to be cooled by the fluid, whereas, on the one hand, the path 1B is a first fluid outlet, sending the fluid to a heat exchanger, such as a radiator, designed to lower the temperature of the fluid passing therethrough, before the fluid is sent to the engine to be cooled, and the path 1C forms a second fluid outlet, which sends the fluid to the engine without passing through the aforementioned heat exchanger. The path 1C can e.g. be connected and thereby supply a bypass. Thereby, the cooling fluid sent to the engine by the valve 1 comes at least from the ports 1B and 1C and, after cooling the engine, is returned to the valve, more precisely to at least the path 1A thereof. Nonetheless, the application example discussed in detail hereinabove is not restrictive for the valve 1, in the sense that the valve can be used in many other contexts for the aforementioned circuit. For example, as a variant to the aforementioned application example, the path 1C may be provided for the flow of fluid to or from a forced-air heater, in particular intended for heating the passenger compartment of a vehicle equipped with the abovementioned engine.

The valve 1 comprises a housing 10 which is a single-piece, i.e. consists of a single piece. In other words, the housing 10 has a one-unit structure and can thereby be handled in one piece, in particular during assembly of the valve 1. In practice, the housing 10 is made of a plastic material or of a metal alloy, in particular an aluminum alloy.

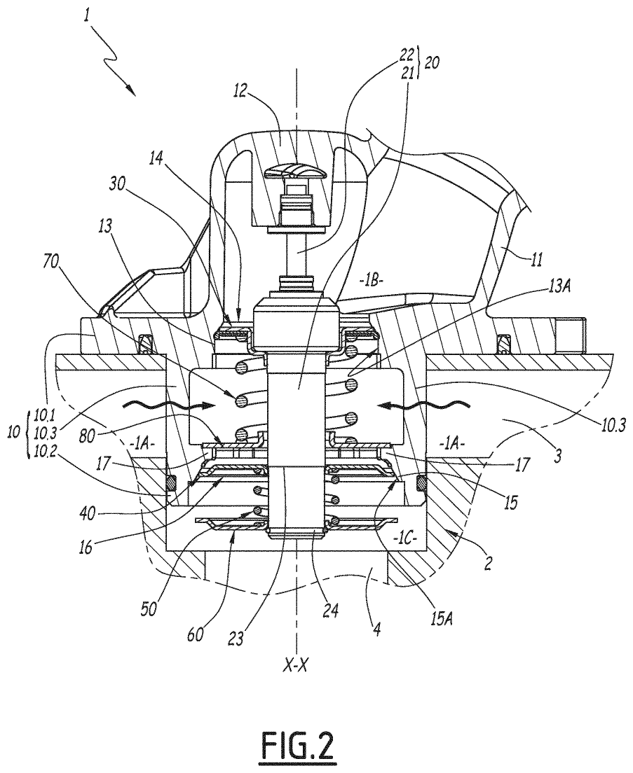

The housing 10 defines the paths 1A, 1B and 1C, in the sense that the rest of the valve 1 regulates the flow of fluid through the housing 10 between the paths 1A, 1B and 1C. The flow of the fluid through the housing 10 is shown schematically by wavy arrows in FIGS. 2 to 5.

In the embodiment considered in the Figures, the housing 10 includes a conduit 11 which channels the fluid along the path 1B and which can be connected to the aforementioned circuit. In practice, the embodiment of the conduit 11 is not limiting, the conduit 11 can moreover be replaced by alternative arrangements aimed at connecting the path 1B to the aforementioned circuit. In addition, as illustrated in FIGS. 2 to 5, the housing 10 is designed to be directly mounted fixedly to a shell 2 belonging to the aforementioned circuit and comprising conduits 3 and 4. When the housing 10 is fastened to the shell 2, the conduit 3 is connected to the housing 10 by being in communication with the path 1A and the conduit 4 is connected to the housing 10 by being in communication with the path 1C. Here again, the embodiment of the shell 2 is not limiting, so that the shell 2 is also shown only partially and schematically in FIGS. 2 to 5. As an example, but not limited to, the shell 2 belongs to a casing of the aforementioned engine. Moreover, the layouts of the housing 10 relating to the fastening to the shell 2 are not limiting and are thus shown only in a partial and schematic manner in the Figures.

The valve 1 includes a thermostatic element 20 which is centered on a geometric axis X-X. The thermostatic element 20 includes a body 21 centered on the axis X-X and containing a thermally expandable material, such as a wax, not visible in the Figures. The thermostatic element 20 further comprises a piston 22, the longitudinal geometric axis of which is aligned with the axis X-X and an axial end portion which is engaged inside the body 21 so that the thermally expandable material contained in the body 21 can act on the axial end portion of the piston 22. The body 21 and the piston 22 are movable relative to each other in translation along the axis X-X: under the effect of an expansion of the thermally expandable material, the piston 22 deploying outside the body 21, whereas, during contraction of the thermally expandable material, the piston is retractable inside the body 21.

In the assembled state of the valve 1, the piston 22 of the thermostatic element 20 is fixedly connected to the housing 10. More precisely, the terminal part of the piston 22, opposite the part arranged inside the body 21, is fixedly connected, at least along the axis X-X, to a wall 12 of the housing 10, arranged across the axis X-X. In practice, various embodiments can be envisaged with regard to the fixed connection of the aforementioned end part of the piston 22 to the wall 12 of the housing 10: the fixed connection can be achieved either solely by axial support, or by removable fastening, such as a clipping or a sliding fitting, or by permanent securing such as force-fitting, overmolding or the addition of a mechanical holding system. In all cases, it should be understood that, when the thermally expandable material contained in the body 21 expands or contracts, the piston 22 is held immobile with respect to the housing 10, because of the fixed connection of the aforementioned end part thereof to the wall 12 of the housing, while the body 21 moves away from, respectively approaches, the piston 22 along the axis X-X.

In the embodiment considered herein, the thermostatic element 20 is said to be controlled, in the sense that the piston 22 thereof incorporates an electrical heating resistor which is not visible in the Figures and which, when supplied with electricity, generates heat. The heat is transmitted to the thermally expandable material contained in the body 21 for the purpose of expanding the material, in addition to or as a replacement for the heat that the fluid wherein the body 21 is located can provide. To this end, the housing 10 is equipped with electrical connection elements between the electrical heating resistor and the outside of the housing 10, the electrical connection elements typically being arranged across the wall 12 of the housing. In practice, the arrangements of the valve 1 relating to the control of the thermostatic element 20 thereof are known per se in the field and will not be described further herein. In a variant (not shown), the thermostatic element 20 is not controlled, i.e. it is devoid of any electrical heating resistance: in such case, the heating of the thermally expandable material is induced exclusively by the heat of the fluid wherein the body 21 is located.

For convenience, the rest of the description is oriented with respect to the axis X-X considering that:
“downwards” or similar expressions correspond to a direction which is parallel to the axis X-X and the direction of which corresponds to a direction of deployment for the body 21 of the thermostatic element 20, i.e. the direction wherein the body 21 deploys, i.e. moves away, with respect to the piston 22 when the thermally expandable material contained in the body 21 expands, and
“upwards” or similar expressions correspond to a direction which is parallel to the axis X-X and the direction of which corresponds to a return direction for the body 21, i.e. the direction wherein the body 21 approaches the piston 22, in other words, is returned toward the piston 22 when the thermally expandable material contracts.

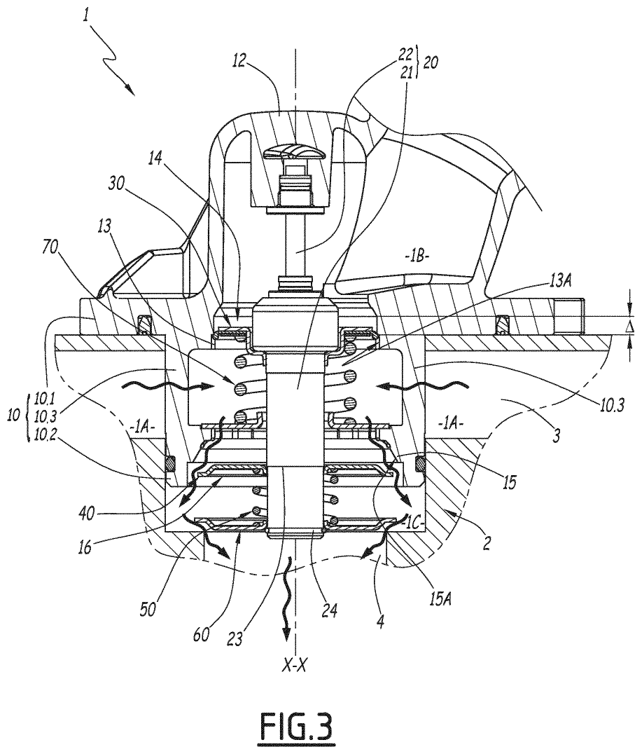

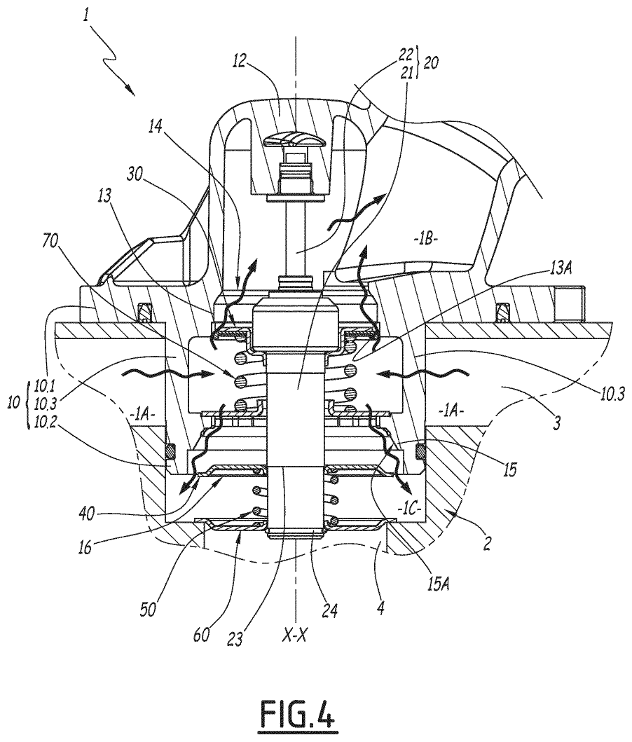

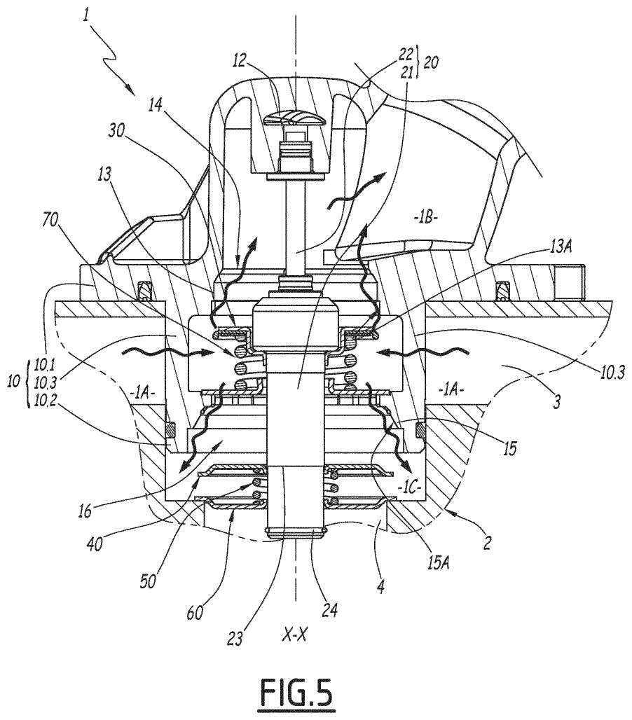

The valve 1 further comprises a plug 30. The plug 30 can move along the axis X-X with respect to a seat 13, which is integrated into the housing 10, so as to open and close a passage 14 making the paths 1A and 1B communicate through the housing 10. The passage 14 is delimited by a part 10.1 of the housing 10, which integrates the seat 13, i.e. the seat 13 being fixedly and permanently connected to the part 10.1 of the housing 10, in particular by being integral with the part 10.1. In the embodiment considered in the Figures, the part 10.1 of the housing 10 also includes the conduit 11 and the wall 12. In all cases, the plug 30 can thereby be moved between:
a closed configuration, which is illustrated in FIGS. 2 and 3 and wherein the plug 30 closes the passage 14, being in contact with the seat 13, the contact being leak-tight in the sense that, except for marginal leaks, same prevents fluid from flowing between paths 1A and 1B through the housing 10, and
an open configuration, which is illustrated in FIGS. 4 and 5 and wherein the plug 30 opens the passage 14, being moved away from the seat 13 to allow the fluid to flow between the paths 1A and 1B through the housing 10, which, in the application example defined hereinabove, amounts to allowing at least part of the fluid entering via the path 1A to be sent, through the housing 10, into the outlet of the path 1B.

In order to control the displacement of the plug 30, the latter is supported by the body 21 of the thermostatic element 20 so that, during the expansion of the thermally expandable material contained in the body 21 and therefore the corresponding axial deployment of the body 21 with respect to the piston 22, the body 21 moves the plug 30 with respect to the housing 10 from the closed configuration thereof to the open configuration thereof, by means of the axial separation of the plug 30 with respect to the seat 13. More precisely, when the body 21 is thereby deployed within a predetermined stroke, denoted by A in FIG. 3, the plug 30 is moved by the body 21 while remaining in the closed configuration, as illustrated by FIGS. 2 and 3, whereas, when the body 21 is deployed beyond the predetermined travel A, the plug 30 is moved by the body 21, having passed into the open configuration, as illustrated by FIGS. 4 and 5. Thereby, to move the plug 30 from the closed configuration thereof to the open configuration thereof, the expansion of the thermally expandable material should be sufficiently significant for the deployment of the body 21 with respect to the piston 22 to exceed the predetermined stroke A, whereas, as long as the deployment of the body 21 with respect to the piston 22 remains less than the predetermined travel A because the expansion of the thermally expandable material is lesser, the plug 30 is moved correspondingly with respect to the housing 10 while remaining in the closed configuration.

To this end, in the embodiment considered in the Figures, the seat 13 comprises a contact surface 13A which is cylindrical, being centered on the axis X-X, and the axial extent of which is equal to the predetermined stroke A. In the embodiment considered herein, the contact surface 13A is formed inside the passage 14. The plug 30 in the closed configuration is pressed radially against the contact surface 13A, so as to seal the corresponding radial support, including when the plug 30 axially sweeps the contact surface 13A because of the axial drive thereof by the body 21. Downwards, the contact surface 13A opens onto a free internal volume of the housing 10, interrupting the seat 13 in the sense that, when the plug 30 is located in the free internal volume, same is in the open configuration, by being sufficiently spaced from the seat 13 to allow fluid to flow between the paths 1A and 1B via the passage 14.

In the embodiment considered in the Figures, the plug 30 is similar to a disk, but such embodiment is not limiting. Similarly, the plug 30 is fixedly connected to the body 21 of the thermostatic element 20, e.g. by being fitted tightly around the body 21, it being noted, however, that the specificities relating to the fixed connection between the plug 30 and the body 21 are not limiting since multiple embodiments can be envisaged.

The valve 1 also comprises a plug 40 which is distinct from the plug 30. The plug 40 is movable along the axis X-X with respect to a seat 15, which is integrated into the housing 10, so as to open and close a passage 16 making the paths 1A and 1C communicate through the housing 10. The passage 16 is delimited by a part 10.2 of the housing 10, which integrates the seat 15, i.e. the seat 15 being fixedly and permanently connected to the part 10.2 of the housing 10, in particular by being integral with the part 10.2. The plug 40 can thus be moved between:
a closed configuration, which is illustrated in FIG. 2 and wherein the plug 40 closes the passage 16, being in contact with the seat 15, the contact being sealed in the sense that, give or take for marginal leaks, same prevents fluid from flowing between the paths 1A and 1C through housing 10, and
an open configuration, which is illustrated in FIGS. 3 to 5 and wherein the plug 40 opens the passage 16, being moved away from the seat 15 to allow the fluid to flow between the paths 1A and 1C through the housing 10, which, in the application example defined hereinabove, amounts to allowing at least part of the fluid entering via the path 1A to be sent, through the housing 10, into the outlet of the path 1C.

In order to control the displacement of the plug 40, the latter is supported by the body 21 of the thermostatic element 20 so that, during the expansion of the thermally expandable material contained in the body 21 and therefore the corresponding axial deployment of the body 21 with respect to the piston 22, the body 21 moves the plug 40 with respect to the housing 10 from the closed configuration thereof to the open configuration thereof, by means of the axial separation of the plug 40 with respect to the seat 15. Unlike the plug 30, the plug 40 has thereby moved from the closed configuration thereof to the open configuration thereof when the body 21 is deployed with respect to the piston 22 within the predetermined stroke A. Of course, the plug 40 remains in the open configuration when the body 21 is deployed beyond the predetermined travel A. Thereby, to move the plug 40 from the closed configuration thereof to the open configuration thereof, the expansion of the thermally expandable material does not have to be as significant as to move the plug 30 from the closed configuration thereof to the open configuration thereof. Thereof is equivalent to saying that, when the body 21 deploys progressively with respect to the piston 22, first below and then beyond the predetermined stroke A during the expansion of the thermally expandable material, the plug 40 first moves from the closed configuration thereof to the open configuration thereof whereas the plug 30 remains in the closed configuration thereof, as shown in FIG. 3, and then after plug 40 has moved to the open configuration thereof, the plug 30 moves from the closed configuration thereof to the open configuration thereof, as shown in FIG. 4.

To this end, in the embodiment considered in the Figures, the seat 15 comprises a contact surface 15A which is oriented transversely to the axis X-X and against which the plug 40 is pressed upwards when the plug 40 is in the closed configuration thereof. In the embodiment considered herein, the contact surface 15A is formed inside the passage 16 and has a frustoconical shape which is centered on the axis X-X and converges upwards. In addition, the plug 40, which herein is similar to a disk, is mounted on the body 21 so as to be movable in translation along the axis X-X, being locked upwards by an ad hoc stop 23 of the body 21, herein formed by a shoulder of the body 21. A holding spring 50, which is compressed along the axis X-X and which is arranged coaxially around the body 21, tends to hold the plug 40 against the stop 23. In this way, the plug 40 in the closed configuration is maintained in axial abutment against the seat 15 without inducing any overstress on the housing 10 in the case where the return of the body 21 toward the piston 22 during the contraction of the thermally expandable material would be such that the abutment 23 would be moved away towards the top of the plug 40. Nonetheless, as a variant (not shown), the plug 40 may be fixedly connected to the body 21; more generally, multiple embodiments may be envisaged for the connection between the body 21 and the plug 40 and for the contact cooperation between the plug 40 and the seat 15.

Before describing the other components of the valve 1, it should be noted that, according to an advantageous arrangement which is implemented in the embodiment considered in the Figures, the housing 10 comprises arms 10.3, herein two arms, which each connect the parts 10.1 and 10.2 of the housing 10 to each other. With regard to the single-piece structure of the housing 10, it should be understood that the parts 10.1 and 10.2 and the arms 10.3 are integral with one another. The arms 10.3 are distributed around the axis X-X, herein being diametrically opposite one another, so as to form therebetween, in a direction peripheral to the axis X-X, free passages, as clearly visible in FIG. 1. The fluid flowing in the path 1A passes through the free passages so as, depending on the direction of the flow, to enter the housing 10 from the conduit 3 of the shell 2 or to leave the housing 10 in the conduit 3.

According to another possible arrangement, which is implemented in the embodiment considered in the Figures, the valve 1 includes a plug 60 which is distinct from the plugs 30 and 40. The plug 60 is movable along the axis X-X with respect to the housing 10 so as to open and close the conduit 4 of the shell 2 when the housing 10 is fastened to the shell 2. For the purpose of controlling the displacement hereof relative to the housing 10, the plug 60 is supported by the body 21 of the thermostatic element 20 so that, during the expansion of the thermally expandable material contained in the body 21, the body 21 moves the plug 60 axially so as to:
as long as the plug 30 is in the closed configuration thereof, keep the plug 60 away from the conduit 4 to leave the latter open and thereby free to communicate with the path 1C, as illustrated in FIGS. 2 and 3, and
after the plug 30 has been moved to the open configuration thereof, bring the plug 60 into contact with the shell 2 to close the conduit 4 and thereby prevent the fluid from flowing between the path 1C and the conduit 4, as illustrated in FIGS. 4 and 5.

Thereby, the body 21 controls the displacement of the plug 30 and the plug 60 in reverse, closing one when the other opens, and vice versa. In the context of the application example defined hereinabove, the closing of the conduit 4 by the plug 60 results in all the fluid entering via the path 1A being sent, through the housing 10, into the outlet of the path 1B, the plug 30 then necessarily being in the open configuration.

In the embodiment considered in the Figures, the plug 60 is similar to a disk, but such embodiment is not limiting. Similarly, as regards the connection in displacement between the plug 60 and the body 21, one possibility consists of a fixed connection, at least along the axis X-X. Nonetheless, according to another possibility, which is advantageously implemented in the embodiment considered in the Figures, the plug 60 is mounted on the body 21 so as to be movable in translation along the axis X-X, by being locked downwards by an ad hoc stop 24 of the body 21, herein formed by a circlip directly mounted fixedly around the body 21. The holding spring 50 tends to hold the plug 60 against the stop 24, the holding spring 50 being interposed axially between the plugs 40 and 50. In this way, when the plug 60 closes the conduit 4, the plug 60 is maintained in axial abutment against the shell 2, while allowing the body 21 to be deployed with respect to the piston 22 to the point of moving the stop 24 downwards with respect to the plug 60, as in FIG. 5.

The valve 1 further comprises a return spring 70 which, when the thermally expandable material contained in the body 21 contracts, returns the body 21 toward the piston 22 so as to be able to move the plugs 30 and 40 from the open configuration to the closed configuration, while opening the plug 60. More precisely, when, during contraction of the heat-expandable material, the body 21 is returned toward the piston 22 after the body 21 has been deployed with respect to the piston 22 beyond the predetermined stroke A, the body 21 moves the plugs 30, 40 and 60, first, by moving the plug 30 from the open configuration thereof to the closed configuration thereof and by opening the plug 60, then by moving the plug 40 from the open configuration thereof to the closed configuration thereof.

To this end, the return spring 70 is arranged within the valve 1 so as to be compressed along the axis X-X by generating opposing forces transmitted to the housing 10 and to the body 21, respectively. In practice, multiple possibilities of corresponding layout are conceivable. According to a particularly advantageous arrangement, which is implemented in the embodiment considered in the Figures, the thermostatic valve 1 comprises a force take-up support 80 which, as clearly visible both in FIG. 1 and in FIGS. 2 to 5, extends transversely to the axis X-X so as to form an axial downward support for the return spring 70. The force take-up support 80 is retained axially downwards by the housing 10, being located axially between the seats 13 and 15. Upwards, the return spring 70 is pressed axially against the body 21, where appropriate with interposition of the plug 30 as in the embodiment considered in the Figures. In order for the housing 10 to retain the force take-up support 80 axially downwards, the housing 10 advantageously includes lugs 17, herein two lugs, and against which the force take-up support 80 is locked downwards. The lugs 17 are distributed around the axis X-X, being herein diametrically opposite one another, so as to form therebetween free passages along a direction peripheral to the axis X-X. By providing that, on the one hand, the force take-up support 80 is, in orthogonal projection in a geometric plane perpendicular to the axis X-X, inscribed inside the seat 15 and, on the other hand, the force take-up support 80 is mounted on the body 21 so as to be movable both in translation along the axis X-X and in rotation about the axis X-X, the free passages formed between the lugs 17 allow the force take-up support 80 to pass when same is mounted on the body 21 via the inside of the seat 15: during the assembly of the valve 1, it is thereby possible to engage the force take-up support 80 around the lower end of the body 21, then to translate the force take-up support 80 upwards along the body 21; during the upward translation, the force take-up support 80 passes inside the seat 15, without interfering with same and then the angular position of the force take-up support 80 about the axis X-X can be freely modified in order to cause the force take-up support 80 to pass through the free passages formed between the lugs 17; such upward translation is continued until the force take-up support 80 is positioned above the lugs 17; the angular position of the force take-up support 80 about the axis X-X is then adjusted so as to align the force take-up support 80 axially with the lugs 17; the force take-up support 80 is then translated downwards, until the force take-up support 80 comes to bear downwards against the lugs 17.

In order to ensure that, during the assembly of the valve 1, it is possible to insert the plug 30 inside the housing 10 through the interior of the seat 15 in order to reach the seat 13, it is provided that, in orthogonal projection on a geometrical plane perpendicular to the axis X-X, the plug 30 is inscribed inside the seat 15. In the embodiment considered in the Figures, and in continuation of the foregoing considerations, an advantageous optional arrangement consists in providing that, in orthogonal projection in a geometrical plane perpendicular to the axis X-X, the plug 30 is inscribed in a circle centered on the axis X-X and which is tangent to the lugs 17. In this way, during assembly of the valve 1, it is possible to make the plug 30 pass through the inside of the seat 15 to reach the seat 13. More particularly, according to a practical implementation, the body 21, the plugs 30, 40 and 60, the retaining spring 50, the return spring 70 and the force take-up support 80 are preassembled to one another and then the corresponding preassembled assembly is assembled to the housing 10, equipped beforehand, where appropriate, with the piston 22, the preassembled assembly being inserted from the bottom upwards inside the housing 10 passing through the inside of the seat 15.

The operation of the valve 1 will now be described with reference to FIGS. 2 to 5, within the framework of the application example defined hereinabove.

In the operating configuration shown in FIG. 2, the fluid entering via path 1A is, at the same time, prevented by the plug 30 in the closed configuration from flowing into the path 1B through the housing 10 and prevented by the plug 40 from flowing into the path 1C through the housing 10. Such operating configuration occurs when the fluid of the path 1A has a low temperature. Such is typically the case when starting the engine mentioned hereinabove and intended to be cooled by the fluid. Thereby, at the start-up of the engine and in the instants which follow, it is sought that the fluid of the path 1A does not flow either toward the exchanger via the path 1B nor in bypass of the exchanger via the path 1C.

If the temperature of the fluid in the path 1A increases and/or the electrical heating resistance of the piston 22 is heated, the thermally expandable material of the thermostatic element 20 expands. The body 21 then deploys with respect to the piston 22 and drives the plugs 30, 40 and 60 downwards, as illustrated in FIGS. 3 to 50. As long as the deployment of the body 21 does not exceed the predetermined travel A, the body 21 makes the plug 40 move from the closed configuration thereof to the open configuration thereof, while maintaining the plug 30 in the closed configuration thereof and leaving the conduit 4 open by the plug 60: the valve 1 is then in the configuration illustrated in FIG. 3 and the fluid taken in the path 1A is then totally sent, via the path 1C, into the conduit 4. When the deployment of the body 21 exceeds the predetermined stroke A, the body 21 switches the plug 30 from the closed configuration thereof to the open configuration thereof and then makes the plug 60 close the conduit 4: the valve 1 is then in the configuration illustrated in FIG. 4 and all fluid taken into the path 1A is sent to the path 1B through the housing 10. Of course, between the configurations illustrated in FIGS. 3 and 4, respectively, the valve 1 is in an operating configuration where the plug 30 is already in the open configuration while the conduit 4 is not yet closed by the plug 60: the fluid taken into the path 1A is then distributed between the path 1B and, via the path 1C, the conduit 4. If the thermally expandable material continues to expand until moving the body 21 over a stroke greater than the stroke just necessary for the abutment of the shut-off 60 on the shell 2 in order to close the duct 4, the valve 1 reaches the operating configuration illustrated in FIG. 5.

If the thermally expandable material of the thermostatic element 20 then contracts, the body 21 is returned toward the piston 22 under the decompression effect of the return spring 70. The valve 1 then moves from the configuration shown in FIG. 5 to the configuration shown in FIG. 4, then to the configuration shown in FIG. 3, then to the configuration shown in FIG. 2.

Moreover, various layouts and variants of the valve 1, as described up to now, are conceivable. Examples include:
rather than fixedly connecting the piston 22 of the thermostatic element 20 to the housing 10, it may be the body 21 of the thermostatic element which is provided fixed with respect to the housing 10, the piston 22 then forming the movable part of the thermostatic element, by providing the function of controlling the displacement of the plugs 30, 40 and 60, described for the body 21 in connection with the embodiment illustrated in the Figures;
rather than being fixedly connected to the movable part of the thermostatic element 20, the plug 30 can be mounted on the movable part with freedom of movement along the axis X-X, provided same is associated with a dedicated return spring; the plug 30 can then integrate an offloading function in the event of a pressure difference on either side of the plug;
in a variant (not shown), the valve 1 is not provided with the plug 60, but can advantageously remain provided with a retaining spring similar to the retaining spring 50, which, opposite the upwards abutment on the plug 50, abuts downwards, directly or indirectly, on the movable part of the thermostatic element 20; and/or
also in a variant (not shown), the valve 1 may not have the force take-up support 80, by then providing suitable layouts for transmitting to the housing 10 the force generated by the return spring 70 in a manner opposite to the force thereof transmitted to the movable part of the thermostatic element 20; for example, the return spring 70 can bear directly on the housing 10; in such case, provision is still made that, in orthogonal projection on a geometric plane perpendicular to the axis, the plug 30 is inscribed inside the seat 15, in order to facilitate the assembly of the valve 1 by allowing the plug 30 to be inserted inside the housing 10 via the inside of the seat 15.

The invention relates to valve comprising a single-piece housing (10) and a thermostatic element (20) made of thermally expandable material, including a fixed portion (22) and a mobile portion (21). A first plug (30) is axially movable relative to a first seat (13) integrated into the housing between closed and open configurations in order to control the flow of fluid between first and second paths (1A, 1B) and is carried by the mobile portion in such a way that it moves the first plug by causing it to remain in the closed configuration when deployed below a predetermined stroke (Δ) and to move to an open configuration when deployed beyond that stroke. A second plug (40) is axially movable relative to a second seat (15) integrated into the housing and axially spaced apart from the first seat between closed and open configurations in order to control the flow of fluid between the first and a third (1C) path and is carried by the mobile portion in such a way that it moves the second plug from the closed configuration to the open configuration when deployed below the predetermined stroke. Moreover, in orthogonal projection on a geometric plane perpendicular to the axis, the first plug is inscribed inside the second seat.

1. A thermostatic valve, including:
a housing, which is single-piece and through which a fluid can flow between first, second and third paths,
a thermostatic element which includes a fixed part, fixedly connected to the housing, and a movable part, movable along an axis with respect to the fixed part, the mobile part deploying axially with respect to the fixed part under the action of an expansion of a thermally expandable material of the thermostatic element,
a first plug which is:
axially displaceable relative to a first seat, which is integral with the housing, between a first closed configuration, wherein the first plug is in contact with the first seat so as to prevent fluid from flowing between the first and second paths through the housing, and a first open configuration, wherein the first plug is spaced from the first seat so as to allow fluid to flow between the first and second paths through the housing, and
supported by the movable part so that, during the expansion of the thermally expandable material, the movable part moves the first plug relative to the housing by making, on the one hand, the first plug stay in the first closed configuration when the movable part is extended relative to the fixed part within a predetermined stroke and, on the other hand, moving the first plug into the first open configuration when the movable part is deployed relative to the fixed part beyond said predetermined stroke, and
a second plug which is:
axially displaceable in relation to a second seat, which is integrated into the housing and is axially spaced from the first seat, between a second closed configuration, wherein the second plug contacts the second seat so as to prevent fluid from flowing between the first and third paths through the housing, and a second open configuration, wherein the second plug is spaced from the second seat so as to allow fluid to flow between the first and third paths through the housing, and
supported by the movable part so that, upon expansion of the thermally expandable material, the movable part moves the second plug relative to the housing by moving the second plug from the second closed configuration to the second open configuration when the movable part is deployed relative to the fixed part within said predetermined stroke,
and wherein, in orthogonal projection on a geometric plane perpendicular to the axis, the first plug is inscribed inside the second seat.

2. The thermostatic valve according to claim 1, wherein the housing includes:
a first part incorporating the first seat and delimiting a passage, which makes communicate the first and second paths and which is closed by the first plug when the first plug is in the first closed configuration, and, on the other hand, left open by the first plug when the first plug is in the first open configuration,
a second part incorporating the second seat and delimiting a passage, which makes communicate the first and third paths and which is, on the one hand, closed by the second plug when the second plug is in the second closed configuration and, on the other hand, left open by the second plug when the second plug is in the second open configuration, and
arms, each connecting the first and second parts to each other and which are distributed around the axis so as to form therebetween, along a direction peripheral to the axis (X-X), free passages through which the fluid flows in the first path.

3. The thermostatic valve according to claim 1, wherein the first seat comprises a contact surface, which is cylindrical, being substantially centered on the axis, which has an axial extent substantially equal to said predetermined stroke, and against which the first plug bears radially when the first plug is in the first closed configuration.

4. The thermostatic valve according to claim 1,
wherein the second seat includes a contact surface which is oriented transversely to the axis and against which the second plug is, when the second plug is in the second closed configuration, axially supported in a return direction wherein the movable part is returned toward the fixed part during a contraction of the thermally expandable material,
wherein the second plug is mounted on the movable part so as to be movable in translation along the axis, being axially locked by a stop of the movable part in said return direction, and
wherein the thermostatic valve comprises a retaining spring, which is compressed along the axis and which tends to hold the second plug axially against the stop of the movable part along said return direction.

5. The thermostatic valve according to claim 1,
wherein the thermostatic valve further includes a return spring, which is compressed along the axis by generating opposing forces transmitted respectively to the housing and to the movable part, and which, during a contraction of the thermally expandable material, returns the movable part toward the fixed part, and
wherein, when, during the contraction of the thermally expandable material, the movable part is returned toward the fixed part after the movable part has been deployed relative to the fixed part beyond said predetermined stroke, the movable part moves the first and second plugs by first moving the first plug from the first open configuration to the first closed configuration and then moving the second plug from the second open configuration to the second closed configuration.

6. The thermostatic valve according to claim 5, wherein the thermostatic valve further includes a force take-up support, which extends transversely to the axis so as to, on the one hand, form an axial support for the return spring along a direction of deployment wherein the movable part deploys relative to the fixed part when the heat expandable material expands, and on the other hand, be axially retained by the housing along said direction of deployment by being located axially between the first and second seats.

7. The thermostatic valve according to claim 6,
wherein the force take-up support is, in orthogonal projection in a geometric plane perpendicular to the axis, inscribed inside the second seat and is mounted on the movable part so as to be movable in translation along the axis and in rotation about the axis, and
wherein the housing includes lugs against which the force take-up support is retained axially along said direction of deployment, the lugs being distributed around the axis so as to form therebetween, along a direction peripheral to the axis, free passages through which the force take-up support passes during the mounting thereof on the mobile part via the inside of the second seat.

8. The thermostatic valve according to claim 7, wherein, in orthogonal projection in a geometric plane perpendicular to the axis, the first plug is inscribed in a circle which is centered on the axis and which is tangent to the lugs.

9. The thermostatic valve according to claim 1,
wherein the housing is suitable for being fixedly attached to a shell which forms a conduit in communication with the third port, and
wherein the thermostatic valve further includes a third plug which is supported by the movable part so that, during the expansion of the thermally expandable material, the movable part displaces the third plug axially with respect to the housing, maintaining, on the one hand, the third plug spaced apart from the conduit as long as the first plug is in the first closed configuration and, on the other hand, the third plug in contact with the shell so as to close the conduit and prevent fluid from flowing between the conduit and the third path after the first plug has been moved to the first open configuration.
